(19) United States
(12) Patent Application Publication
(10) Pub. No.: US 2020/0346475 A1
(43) Pub. Date: Nov. 5, 2020

(54) PAPER SHEET HANDLING APPARATUS AND METHOD OF CONFIGURING PLD IN PAPER SHEET HANDLING APPARATUS

(71) Applicant: FUJITSU FRONTECH LIMITED, Tokyo (JP)

(72) Inventor: Tomoaki OGAWA, Tokyo (JP)

(73) Assignee: FUJITSU FRONTECH LIMITED, Tokyo (JP)

(21) Appl. No.: 16/933,388

(22) Filed: Jul. 20, 2020

Related U.S. Application Data
(63) Continuation of application No. PCT/JP2018/003304, filed on Jan. 31, 2018.

(51) Int. Cl. B41L 39/16; G06F 13/40; G05B 19/045

(52) U.S. Cl. CPC B41L 39/16; G06F 13/409; G05B 2219/21109; G05B 2219/25268; G05B 19/045

(57) ABSTRACT

A paper sheet handling apparatus includes a plurality of mechanical units including a paper sheet handling unit, the plurality of mechanical units each including a processor, a programmable logic device (PLD) controlled by the processor, a first mechanical module including a first mechanical element controlled by the PLD, and an interface that connects a second mechanical module including a second mechanical element, wherein when the processor detects connection of the second mechanical module via the interface, the processor reads, from a second storage included in the second mechanical module, the second storage storing second firmware of the processor configured to control the first mechanical element and the second mechanical element and second data for use in configuring a logic circuit of the PLD configured to control the first mechanical element and the second mechanical element, the second firmware to load the second firmware onto the processor.

### CROSS-REFERENCE TO RELATED APPLICATION

This application is a continuation application of International Application PCT/JP2018/003304, filed on Jan. 31, 2018 and designating the U.S., the entire contents of which are incorporated herein by reference.

### FIELD

The present invention relates to a paper sheet handling apparatus and a method of configuring a PLD in the paper sheet handling apparatus.

### BACKGROUND

Paper currency handling apparatuses such as automatic teller machines (ATMs) include, for example, a coin unit that deals with coins, a paper currency unit that deals with paper currency, and various other mechanical units. Each mechanical unit includes mechanical modules including mechanical elements such as a motor, and the mechanical modules are operated by a programmable logic device (PLD) such as a field-programmable gate array (FPGA) controlled by a central processing unit (CPU). The CPU operates based on firmware loaded on a work area of the CPU. The FPGA is configured based on FPGA data downloaded to a storage area of the FPGA and is operated by the CPU, which operates based on the firmware. The firmware and the FPGA data are configured to support the pre-assumed functions of the mechanical modules.

As a method of updating a computer program of an apparatus, a method is disclosed (see, for example, Patent Document 1) by which a computer program in a read only memory (ROM) of the apparatus is rewritten with a computer program stored in a ROM of a peripheral connected to the apparatus. As a method of updating firmware of an apparatus, a method is disclosed (see, for example, Patent Document 2) by which data in a ROM of the apparatus is rewritten with firmware acquired via the Internet.

Patent Document 1: Japanese Laid-open Patent Publication No. 2003-084978

Patent Document 2: Japanese Laid-open Patent Publication No. 2003-167742

Typically, paper currency handling apparatuses are run without being connected to a network. This configuration prevents distribution of firmware or FPGA data to the paper currency handling apparatuses via the network. In this regard, in adding a function beyond a pre-assumed range to the mechanical modules installed in the paper currency handling apparatuses, workers visit the installation locations of the respective paper currency handling apparatuses to update the firmware and the FPGA data or replace the CPU and a circuit board including the FPGA. Alternatively, in adding a function beyond a pre-assumed range to the mechanical modules installed in the paper currency handling apparatuses, a new model including the additional function is developed. Adding a new function needs many human hours. In other words, conventional techniques have a problem in that paper sheet handling apparatuses including paper currency handling apparatuses fail to add a function to the mechanical modules in an easy manner.

### SUMMARY

According to an aspect of the embodiments, a paper sheet handling apparatus includes: a plurality of mechanical units including a paper sheet handling unit, the plurality of mechanical units each including a processor, a programmable logic device (PLD) controlled by the processor, a first mechanical module including a first mechanical element controlled by the PLD, and an interface that connects a second mechanical module including a second mechanical element, wherein when the processor detects connection of the second mechanical module via the interface, the processor reads, from a second storage included in the second mechanical module, the second storage storing second firmware of the processor configured to control the first mechanical element and the second mechanical element and second data for use in configuring a logic circuit of the PLD configured to control the first mechanical element and the second mechanical element, the second firmware to load the second firmware onto the processor, and the processor reads the second data from the second storage to configure the PLD.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a perspective view illustrating an example external view of a paper currency handling apparatus according to a first embodiment;

FIG. 2 is a schematic diagram illustrating a configuration of a paper currency unit of the paper currency handling apparatus according to the first embodiment;

FIG. 3 is a diagram illustrating an example configuration of the paper currency handling apparatus according to the first embodiment;

FIG. 4 is a diagram illustrating an example of a firmware storage included in the paper currency handling apparatus according to the first embodiment;

FIG. 5 is a diagram illustrating an example of a storage included in the paper currency unit of the paper currency handling apparatus according to the first embodiment;

FIG. 6 is a diagram illustrating an example of a storage included in an optional module of the paper currency unit in the paper currency handling apparatus according to the first embodiment;

FIG. 7 is a diagram illustrating an example general configuration of a mechanical unit in the paper currency handling apparatus according to the first embodiment;

FIG. 8 is a flowchart illustrating an example of function addition and update processing according to the first embodiment; and

FIG. 9 is a diagram illustrating an example general configuration of a mechanical unit in a paper currency handling apparatus according to a second embodiment.

### DESCRIPTION OF EMBODIMENTS

The following describes in detail embodiments of a paper sheet handling apparatus and a method of configuring a PLD in the paper sheet handling apparatus according to the present disclosure with reference to the accompanying drawings. The embodiments below are not intended to limit the scope of the present disclosure. In the embodiments below, a paper currency handling apparatus (what is called an automatic teller machine, or an ATM) is described as an example of the paper sheet handling apparatus, but the present disclosure is not limited to this. The present disclosure is applicable to typical paper sheet handling apparatuses such as teller machines used in banks and ticket vending machines selling, for example, tickets and lotteries.

In the embodiments and modifications below, elements and processes previously described are given the same names or the same reference signs and the description thereof is omitted. Part of or all the embodiments and modifications can be combined and implemented to the extent that the combinations are not contradictory.

### First Embodiment

(External View of Paper Currency Handling Apparatus)

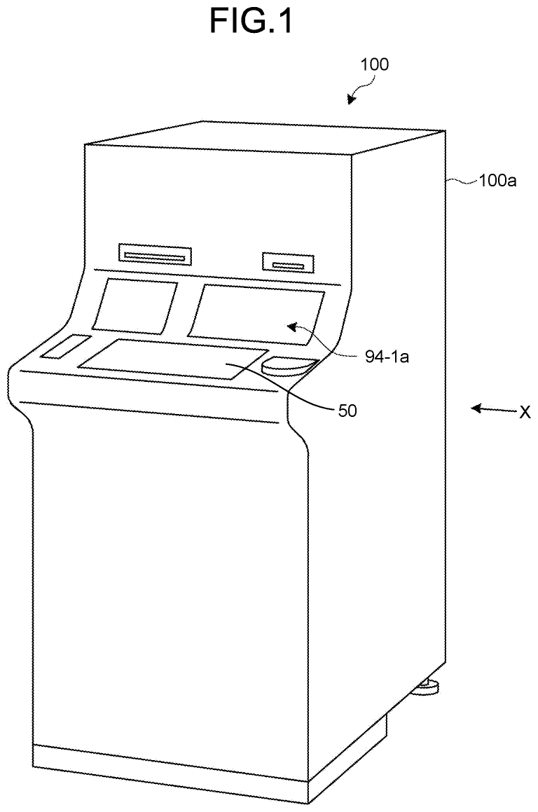

FIG. 1 is a perspective view illustrating an example external view of a paper currency handling apparatus according to a first embodiment. This paper currency handling apparatus 100 according to the first embodiment includes a housing 100a. The paper currency handling apparatus 100 includes, for example, a display panel 50, a passbook slot, a cash card slot, a paper currency slot 94-la, a coin slot, a biological information scanner for biometric authentication, on a side of the housing 100a facing an operator.

(Configuration of Paper Currency Unit in Paper Currency Handling Apparatus)

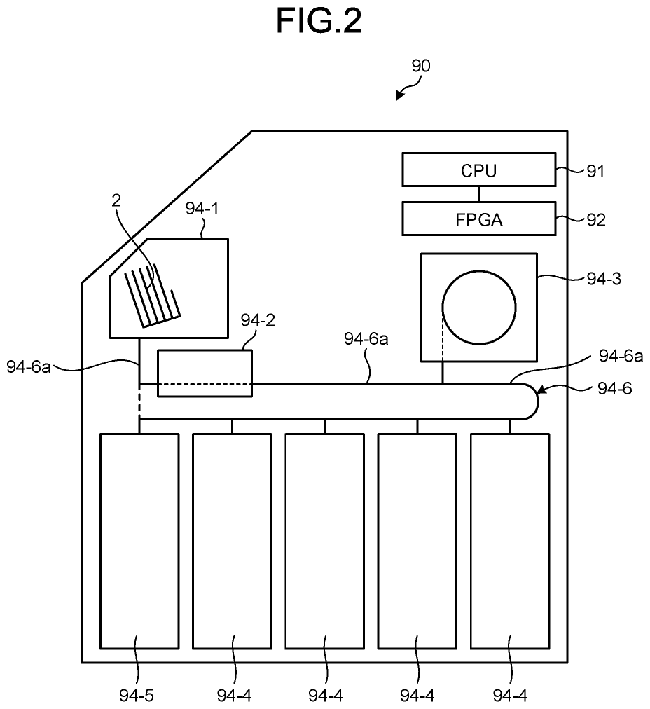

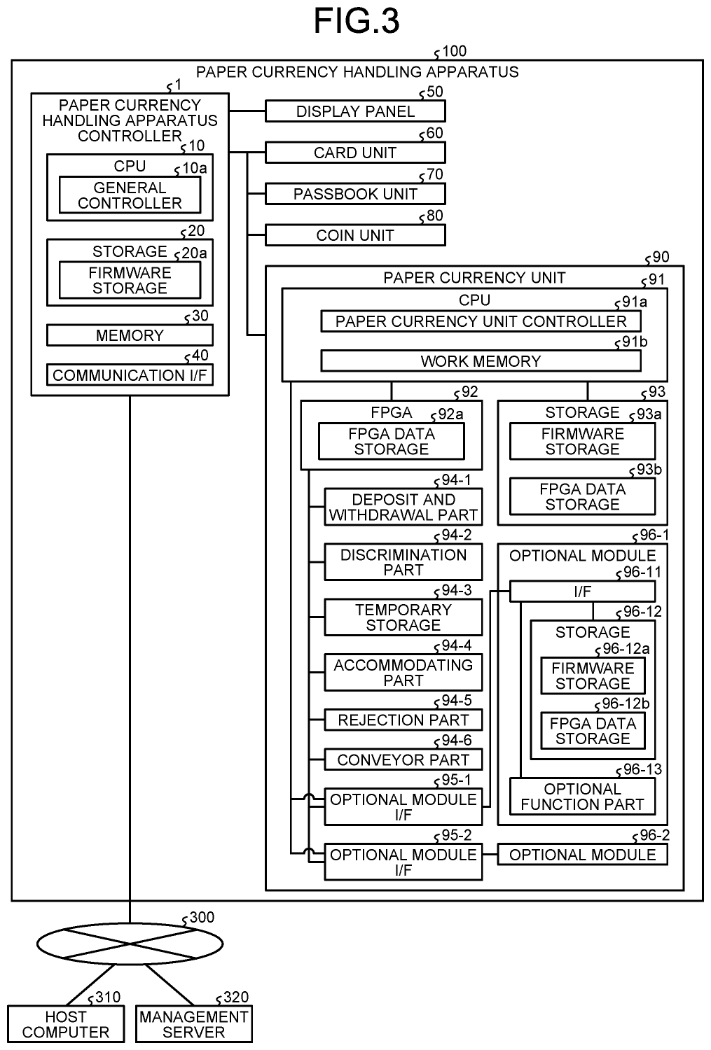

FIG. 2 is a schematic diagram illustrating a configuration of a paper currency unit of the paper currency handling apparatus according to the first embodiment. FIG. 2 is a side view of a paper currency unit 90 seen in an X-direction illustrated in FIG. 1. The paper currency handling apparatus 100 includes a plurality of mechanical units including a card unit 60, a passbook unit 70, a coin unit 80, and the paper currency unit 90 (see FIG. 3), which are described later. In the first embodiment, the general configuration of the paper currency unit 90 is illustrated in FIG. 2, but configurations of the card unit 60, the passbook unit 70, and the coin unit 80 are not illustrated in the drawings.

As illustrated in FIG. 2, the paper currency unit 90 includes a deposit and withdrawal part 94-1 that deposits therein and withdraws therefrom paper currency 2 and a discrimination part 94-2 that discriminates the authenticity of the paper currency 2 deposited into the deposit and withdrawal part 94-1. The paper currency unit 90 further includes a temporary storage 94-3 that takes in the paper currency 2 conveyed from the discrimination part 94-2 and stores the paper currency 2 temporarily, and a plurality of accommodating parts 94-4 that store therein the paper currency 2 conveyed from the temporary storage 94-3. The paper currency unit 90 includes a rejection part 94-5 that retains paper currency 2 to be returned to the operator out of the paper currency 2 deposited from the deposit and withdrawal part 94-1.

The paper currency unit 90 includes a conveyor part 94-6 that conveys the paper currency 2. The conveyor part 94-6 includes a conveyor path 94-6a through which the paper currency 2 is conveyed among the deposit and withdrawal part 94-1, the discrimination part 94-2, the temporary storage 94-3, the accommodating parts 94-4, and the rejection part 94-5. The paper currency unit 90 includes a central processing unit (CPU) 91 that controls the deposit and withdrawal part 94-1, the discrimination part 94-2, the temporary storage 94-3, the accommodating parts 94-4, the rejection part 94-5, and the conveyor part 94-6 via an FPGA 92, which is an abbreviation of a field-programmable gate array. The FPGA is an example of a programmable logic device (PLD) that can change its logic circuit by programming. The CPU is an abbreviation of a central processing unit. The CPU is an example of a processor such as a microcomputer.

(Configuration of Paper Currency Handling Apparatus)

FIG. 3 is a diagram illustrating an example configuration of the paper currency handling apparatus according to the first embodiment. FIG. 3 illustrates the functional configurations of the paper currency handling apparatus 100. The paper currency handling apparatus 100 includes a paper currency handling apparatus controller 1, a CPU 10, a storage 20, a memory 30, a communication I/F 40, the display panel 50, the card unit 60, the passbook unit 70, the coin unit 80, and the paper currency unit 90. The paper currency unit 90 is an example of a paper sheet handing unit. The card unit 60, the passbook unit 70, the coin unit 80, and the paper currency unit 90 may be collectively referred to as “mechanical units”.

The paper currency handling apparatus controller 1 includes the CPU 10, the storage 20, the memory 30, and the communication I/F 40, and controls the paper currency handling apparatus. The CPU 10 controls the entire paper currency handling apparatus 100 upon starting of an operating system (OS) and execution of an application program. The control function implemented by the CPU 10 is illustrated as a general controller 10a. The storage 20 is a storage device such as a flash memory, a hard disk drive (HDD), a solid-state drive (SSD) or a universal serial bus (USB) memory that stores the OS and the application program, and the storage 20 includes a firmware storage 20a for the mechanical units. The firmware storage 20a stores therein, for example, firmware updaters of the respective mechanical units. The updaters may implement differential update or full update. Specifically, the updaters stored in the firmware storage 20a are updaters for the firmware of the card unit 60, the passbook unit 70, the coin unit 80, and the paper currency unit 90. The firmware updater for each mechanical unit includes version status information indicating whether the data is of an older or newer version. The version status information may be referred to as version information. The version status information of firmware is embedded in a prefix or in a suffix relative to a firmware body.

The memory 30 includes a temporary memory and a storage memory. The temporary memory is, for example, a random-access memory (RAM) used as a working area in which data and a computer program are temporarily stored. The storage memory is a flash memory, an HDD, or an SSD, and stores therein a processing program and storage data to be read by, for example, the CPU 10.

The communication I/F 40 is an interface of the paper currency handling apparatus 100 for communicating with a host computer 310 and a management server 320 via a public or closed network 300. The host computer 310 is a host computer of the paper currency handling apparatus 100 and is placed in a host center of a financial institution. The management server 320 is a management server of the paper currency handling apparatus 100 and is owned by a management company of the paper currency handling apparatus 100.

The display panel 50 includes a display part and an operating part. The display part displays, based on an instruction of the general controller 10a, for example, an operation guidance for customers, a transaction menu, and a numeric keypad for input operations. The operating part is, for example, a touch panel integrally installed on the display part and a keyboard, and is configured to detect an input of information by the customer. The operating part transmits detected input information to the general controller 10a.

The card unit 60 conveys a card inserted into the paper currency handling apparatus 100 by a customer to the inside, and accesses a recording portion such as a magnetic stripe or an integral circuit (IC) mounted on the card to read and write information. After accessing the recording portion mounted on the card and reading and writing information from and on the recording portion, the card unit 60 ejects the card to the outside to return the card to the customer. To implement these functions, the card unit 60 includes an FPGA and various types of mechanical modules, but these mechanical modules are not illustrated in the drawings.

The passbook unit 70 conveys a passbook inserted into the paper currency handling apparatus 100 by a customer to the inside, and accesses a recording portion such as a magnetic stripe mounted on the passbook to read and write information. After accessing the recording portion mounted on the passbook and reading and writing information, the passbook unit 70 prints the transaction records on the passbook and ejects the passbook to the outside to return the passbook to the customer. To implement these functions, the passbook unit 70 includes an FPGA and various types of mechanical modules, but these mechanical modules are not illustrated in the drawings.

The coin unit 80 includes a coin cassette (not illustrated) that accommodates coins. The coin unit 80 takes out a certain number of coins from the coin cassette in accordance with a refund instruction in a transaction and discharges the coins to a coin outlet (not illustrated). To implement these functions, the coin unit 80 includes an FPGA and various types of mechanical modules including the coin cassette, but these mechanical modules are not illustrated in the drawings.

The paper currency unit 90 includes the CPU 91, the FPGA 92, the storage 93, the deposit and withdrawal part 94-1, the discrimination part 94-2, the temporary storage 94-3, the accommodating parts 94-4, and the rejection part 94-5. The paper currency unit 90 further includes the conveyor part 94-6, optional module I/Fs 95-1, 95-2, and optional modules 96-1, 96-2. In the following description, the deposit and withdrawal part 94-1, the discrimination part 94-2, the temporary storage 94-3, the accommodating parts 94-4, the rejection part 94-5, and the conveyor part 94-6 may be collectively referred to as the deposit and withdrawal part 94-1 to the conveyor part 94-6. The deposit and withdrawal part 94-1 to the conveyor part 94-6 and the optional modules 96-1, 96-2 are examples of a plurality of mechanical modules.

In the first embodiment, the paper currency unit 90 includes two optional module I/Fs 95-1, 95-2, and two optional modules 96-1, 96-2. However, the number of the optional module I/Fs and the optional modules is not limited to two. In the first embodiment, the CPU 91, the FPGA 92, the storage 93, and the optional module I/Fs 95-1, 95-2 are mounted on a single substrate (main substrate), but the configuration is not limited to this. These elements may be separated as appropriate and mounted on a plurality of substrates (main substrate group).

The CPU 91 reads the firmware from the storage 93 and controls the entire paper currency unit 90. The control function implemented by the CPU 91 is illustrated as a paper currency unit controller 91a. The firmware read by the CPU 91 is loaded on a storage area illustrated as a work memory 91b.

The FPGA 92 includes an FPGA data storage 92a. The FPGA data storage 92a is a storage device such as a static random-access memory (SRAM). The FPGA 92 is configured based on FPGA data downloaded from an FPGA data storage 93b to the FPGA data storage 92a by the paper currency unit controller 91a that operates based on the firmware loaded on the work memory 91b. The FPGA 92 performs, for example, input/output (I/O) control on the mechanical modules that are the deposit and withdrawal part 94-1 to the conveyor part 94-6 and the optional modules 96-1, 96-2 to operate the motors and other mechanical elements included in the mechanical modules.

In the first embodiment, for example, a plurality of mechanical modules are connected to the single FPGA 92. However, the configuration is not limited to this and the mechanical modules may be separated into groups and each group may be connected to a corresponding FPGA. An FPGA may also be provided to the substrate of the mechanical modules and the operation of the mechanical modules may be controlled by the FPGA communicating with the FPGA 92. A bus connecting the optional module I/Fs 95-1, 95-2 with the CPU 91 and a bus connecting the mechanical modules with the FPGA 92 are, for example, serial buses such as serial peripheral interfaces (SPIs). However, the buses are not limited to serial buses and may be parallel buses.

The storage 93 is a storage device such as a flash memory, and includes the firmware storage 93a and the FPGA data storage 93b. The firmware storage 93a stores therein the firmware of the paper currency unit 90 to be loaded on the work memory 91b. The FPGA data storage 93b stores therein the FPGA data of the paper currency unit 90 to be downloaded to the FPGA data storage 92a. The firmware stored in the firmware storage 93a and the FPGA data stored in the FPGA data storage 93b have version status information indicating whether the data is of an older or newer version. The version status information of FPGA data is embedded in a prefix or in a suffix relative to the FPGA data body.

The firmware stored in the firmware storage 93a and the FPGA data stored in the FPGA data storage 93b are firmware and FPGA data of a certain version. The certain version of the firmware and the FPGA data indicates a version of the firmware and the FPGA data that supports the functions and operation of the mechanical modules (deposit and withdrawal part 94-1 to conveyor part 94-6) installed in the paper currency unit 90 of the paper currency handling apparatus 100 at the time of shipment from factory.

The optional module I/Fs 95-1, 95-2 are interfaces that connect, respectively, the optional modules 96-1, 96-2 to the FPGA 92. The optional modules 96-1, 96-2 are connected in parallel with each other to the FPGA 92 via the optional module I/Fs 95-1, 95-2, respectively, and each include a mechanical module for use in adding a function to the paper currency unit 90. The optional module I/Fs 95-1, 95-2 are connected to the CPU 91 so that the CPU 91 can detect the connection of the optional modules 96-1, 96-2.

Since the optional modules 96-1, 96-2 have the same configuration, only the optional module 96-1 is described herein and the optional module 96-2 is not described herein. The optional module 96-1 includes an I/F 96-11, a storage 96-12, and an optional function part 96-13.

In the first embodiment, the I/F 96-11 and the storage 96-12 are mounted on a single substrate (optional substrate), but the configuration is not limited to this. These elements may be separated as appropriate and mounted on a plurality of substrates (optional substrate group). Although the deposit and withdrawal part 94-1 to the conveyor part 94-6 are also connected to the FPGA 92 via interfaces similar to the optional module I/Fs 95-1, 95-2, these interfaces are not illustrated in FIG. 3.

The I/F 96-11 is an interface that connects the optional module 96-1 with the FPGA 92. The storage 96-12 is a storage device such as a flash memory and includes a firmware storage 96-12a and an FPGA data storage 96-12b. The firmware storage 96-12a stores therein the firmware of the paper currency unit 90 to be loaded on the work memory 91b. The FPGA data storage 96-12b stores therein the FPGA data of the paper currency unit 90 to be downloaded to the FPGA data storage 92a. The firmware stored in the firmware storage 96-12a and the FPGA data stored in the FPGA data storage 96-12b have version status information indicating whether the data is of an older or newer version.

The version of the firmware stored in the firmware storage 96-12a and the FPGA data stored in the FPGA data storage 96-12b supports the functions and operation of the existing mechanical modules that are the deposit and withdrawal part 94-1 to the conveyor part 94-6. The version of the firmware stored in the firmware storage 96-12a and the FPGA data stored in the FPGA data storage 96-12b also supports the functions and operation of an additional mechanical module (optional function part 96-13) added to the paper currency unit 90. The firmware and the FPGA data stored in the firmware storage 96-12a and the FPGA data storage 96-12b are newer than the firmware and the FPGA data stored in the firmware storage 93a and the FPGA data storage 93b.

(Firmware Storage Included in Paper Currency Handling Apparatus)

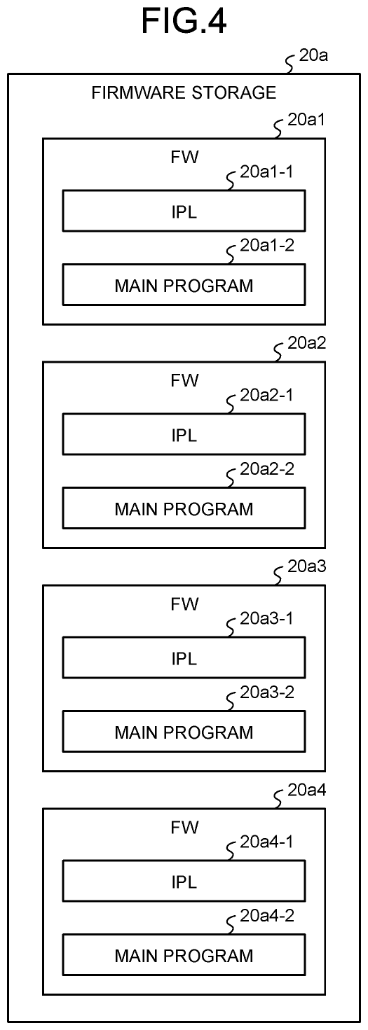

FIG. 4 is a diagram illustrating an example of the firmware storage included in the paper currency handling apparatus according to the first embodiment. The firmware (FW) stored in the firmware storage 20a in the storage 20 of the paper currency handling apparatus 100 is FW updaters to be loaded on the work memory of the respective mechanical units. The mechanical units are the card unit 60, the passbook unit 70, the coin unit 80, and the paper currency unit 90. The firmware may be hereinafter simply referred to as FW. The FW stored in the firmware storage 20a has version status information indicating whether the data is of an older or newer version.

FW 20a1 is FW to be loaded on a work memory (not illustrated) of the CPU of the card unit 60. The FW 20a1 includes an initial program loader (IPL) 20a1-1 and a main program 20a1-2. FW 20a2 is FW to be loaded on a work memory (not illustrated) of the CPU in the passbook unit 70. The FW 20a2 includes an IPL 20a2-1 and a main program 20a2-2. FW 20a3 is FW to be loaded on a work memory (not illustrated) of the CPU in the coin unit 80. The FW 20a3 includes an IPL 20a3-1 and a main program 20a3-2. FW 20a4 is FW to be loaded on the work memory 91b of the CPU 91 in the paper currency unit 90. The FW 20a4 includes an IPL 20a4-1 and a main program 20a4-2.

The version status information on each FW stored in the firmware storage 20a corresponds to the version status information on the main programs 20a1-2 to 20a4-2.

(Storage Included in Paper Currency Unit)

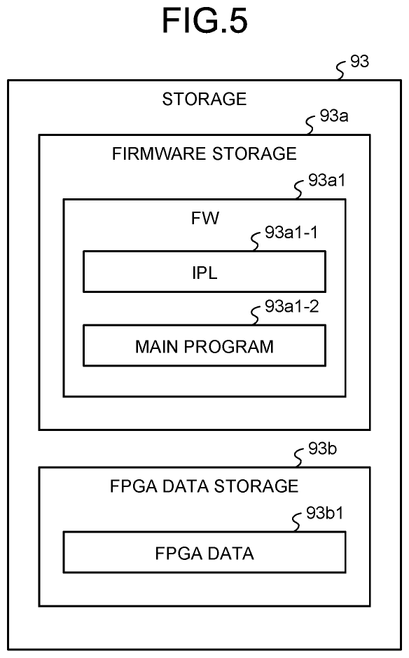

FIG. 5 is a diagram illustrating an example of the storage included in the paper currency unit of the paper currency handling apparatus according to the first embodiment. The firmware storage 93a included in the storage 93 of the paper currency unit 90 stores FW 93a1. The FW 93a1 has version status information indicating whether data is of an older or newer version.

The FW 93a1 is FW to be loaded on the work memory 91b of the paper currency unit 90. The FW 93a1 includes an IPL 93a1-1 and a main program 93a-2. The version status information on the FW stored in the firmware storage 93a is the version status information on the main program 93a1-2.

The FPGA data storage 93b included in the storage 93 in the paper currency unit 90 stores therein FPGA data 93b1. The FPGA data 93b1 has version status information indicating whether data is of an older or newer version. The FPGA data 93b1 is FPGA data to be downloaded to the FPGA data storage 92a of the FPGA 92.

The IPL 93a1-1 is executed by the CPU 91 when the paper currency handling apparatus 100 is powered on and the paper currency unit 90 is activated. In executing the IPL 93a1-1, the CPU 91 first checks whether the optional modules are connected to the optional module I/Fs 95-1, 95-2. When connection of an optional module is detected, the CPU 91 in executing the IPL 93a-1 determines whether the connected optional module includes a storage that stores FW and FPGA data.

When the CPU 91 in executing the IPL 93a1-1 determines that the optional module includes a storage, the CPU 91 determines whether each of the FW and the FPGA data stored in the storage of the optional module and in the storage 93 is of the newest version.

When the CPU 91 in executing the IPL 93a1-1 determines that the version of the firmware stored in the firmware storage of the optional module is newer than the version of the firmware stored in the firmware storage 93a, the CPU 91 performs the following process. That is, the CPU 91 in executing the IPL 93a1-1 loads the firmware stored in the firmware storage of the optional module onto the work memory 91b. When the CPU 91 in executing the IPL 93a1-1 determines that the version of the FPGA data stored in the FPGA data storage of the optional module is newer than the version of the FPGA data stored in the FPGA data storage 93b, the CPU 91 performs the following process. That is, the CPU 91 in executing the IPL 93a1-1 downloads the FPGA data stored in the FPGA data storage of the optional module to the FPGA data storage 92a.

When the CPU 91 in executing the IPL 93a1-1 determines that the version of the firmware stored in the firmware storage 93a is newer than the version of the firmware stored in the firmware storage of the optional module, the CPU 91 performs the following process. That is, the CPU 91 in executing the IPL 93a1-1 loads the firmware stored in the firmware storage 93a onto the work memory 91b. When the CPU 91 in executing the IPL 93a1-1 determines that the version of the FPGA data stored in the FPGA data storage 93b is newer than the version of the FPGA data stored in the FPGA data storage of the optional module, the CPU 91 performs the following process. That is, the CPU 91 in executing the IPL 93a1-1 downloads the FPGA data stored in the FPGA data storage 93b to the FPGA data storage 92a.

The operation of the CPU 91 in executing the IPL 93a1-1 is performed under the condition that the FW and the FPGA data stored in the same storage are of the same version. For example, a case can be considered in which, as for FW, the version of FW stored in the optional module is the newest but, as for FPGA data, the version of FPGA data stored in the optional module is older than that of the FW. As described above, when the versions of the FW and the FPGA data stored in the same storage do not match, the CPU 91 in executing the IPL 93a1-1 may load or download the FW or the FPGA data of the newest version from different storages.

(Storage Included in Optional Module)

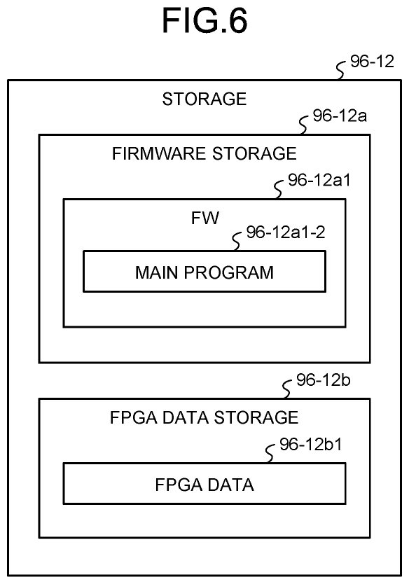

FIG. 6 is a diagram illustrating an example of a storage included in an optional module of the paper currency unit in the paper currency handling apparatus according to the first embodiment. The firmware storage 96-12a included in the storage 96-12 of the optional module 96-1 in the paper currency unit 90 stores FW 96-12a1. The FW 96-12a1 includes a main program 96-12a1-2. The version status information on the FW 96-12a1 is the version status information on the main program 96-12a1-2.

The FPGA data storage 96-12b included in the storage 96-12 of the optional module 96-1 in the paper currency unit 90 stores FPGA data 96-12b1. The FPGA data 96-12b1 has version status information indicating whether data is of an older or newer version.

(General Configuration of Mechanical Unit in Paper Currency Handling Apparatus)

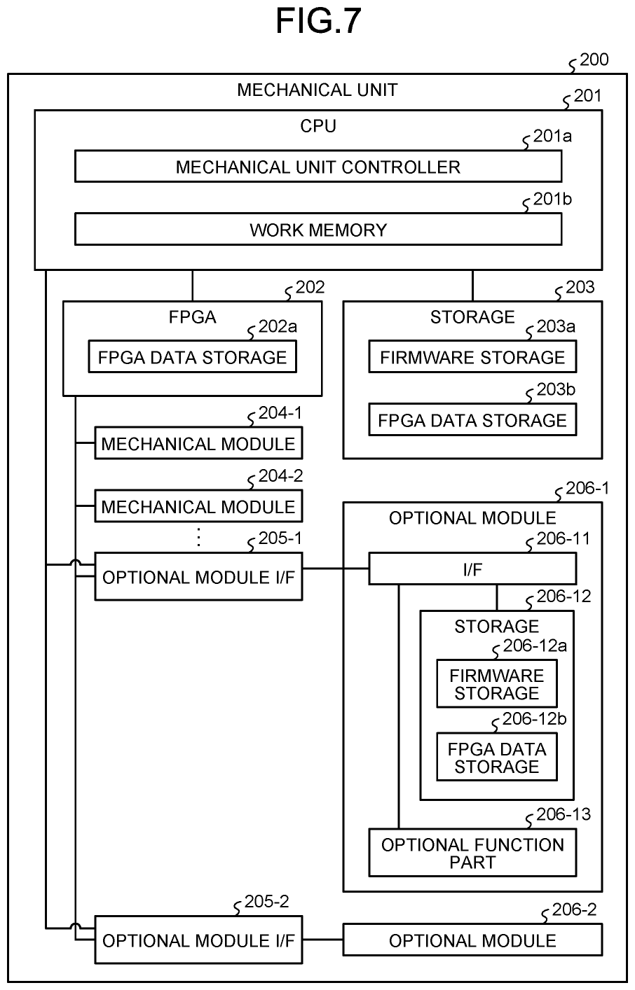

FIG. 7 is a diagram illustrating an example general configuration of a mechanical unit in the paper currency handling apparatus according to the first embodiment. In the description above, out of the card unit 60, the passbook unit 70, the coin unit 80, and the paper currency unit 90, only the specific configuration of the paper currency unit 90 is described, and the specific configurations of the card unit 60, the passbook unit 70, and the coin unit 80 are omitted from the description. FIG. 7 is a diagram collectively illustrating the configuration of the card unit 60, the passbook unit 70, the coin unit 80, and the paper currency unit 90 as the configuration of a mechanical unit 200.

The mechanical unit 200 includes a CPU 201, an FPGA 202, a storage 203, mechanical modules 204-1, 204-2, . . . , optional module I/Fs 205-1, 205-2, and optional modules 206-1, 206-2. Although FIG. 7 illustrates two optional modules 206-1, 206-2 that are connected in parallel with each other to the FPGA 202 via the optional module I/Fs 205-1, 205-2, respectively, the number of the mechanical modules is not limited to two. In FIG. 7, the mechanical unit 200 includes two optional module I/Fs 205-1, 205-2, and the two optional modules 206-1, 206-2. However, the number of the optional module I/Fs and the optional modules is not limited to two.

When, for example, the mechanical unit 200 is the paper currency unit 90, the CPU 201 corresponds to the CPU 91, a mechanical unit controller 201a corresponds to the paper currency unit controller 91a, and a work memory 201b corresponds to the work memory 91b. In the same manner, the FPGA 202 corresponds to the FPGA 92, and an FPGA data storage 202a corresponds to the FPGA data storage 92a.

In the same manner, the storage 203 corresponds to the storage 93, a firmware storage 203a corresponds to the firmware storage 93a, and an FPGA data storage 203b corresponds to the FPGA data storage 93b.

In the same manner, the mechanical modules 204-1, 204-2, . . . , correspond to the deposit and withdrawal part 94-1 to the conveyor part 94-6. In the same manner, the optional module I/Fs 205-1, 205-2 correspond to the optional module I/Fs 95-1, 95-2. In the same manner, the optional modules 206-1, 206-2 correspond to the optional modules 96-1, 96-2.

An I/F 206-11 of the optional module 206-1 corresponds to the I/F 96-11 of the optional module 96-1, and a storage 206-12 corresponds to the storage 96-12. A firmware storage 206-12a corresponds to the firmware storage 96-12a and an FPGA data storage 206-12b corresponds to the FPGA data storage 96-12b. An optional function part 206-13 corresponds to the optional function part 96-13.

(Function Addition and Update Processing of Mechanical Module)

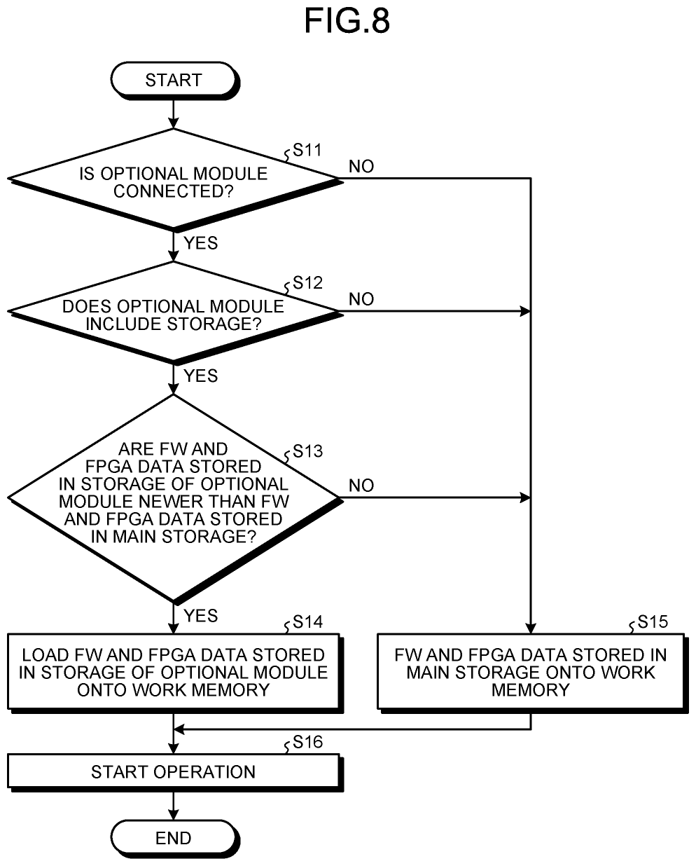

FIG. 8 is a flowchart illustrating an example of function addition and update processing of the mechanical modules according to the first embodiment. The function addition and update processing of the mechanical modules according to the first embodiment is performed by the CPU 201 in executing the IPL of the firmware stored in the firmware storage 203a when the paper currency handling apparatus 100 is powered on and the mechanical unit 200 is activated.

First, at Step S11, the CPU 201 determines whether the optional modules 206-1, 206-2 are connected to the optional module I/Fs 205-1, 205-2. If the CPU 201 determines that the optional modules 206-1, 206-2 are connected to the optional module I/Fs 205-1, 205-2 (Yes at Step S11), the process proceeds to Step S12. If the CPU 201 determines no connection of the optional modules 206-1, 206-2 to the optional module I/Fs 205-1, 205-2 (No at Step S11), the process proceeds to Step S15.

At Step S12, the CPU 201 determines whether the optional modules determined to be connected at Step S11 include a storage that stores firmware and FPGA data. If the CPU 201 determines that the optional modules determined to be connected at Step S11 include a storage that stores firmware and FPGA data (Yes at Step S12), the process proceeds to Step S13. If the CPU 201 determines that the optional modules determined to be connected at Step S11 do not include a storage that stores firmware or FPGA data (No at Step S12), the process proceeds to Step S15.

At Step S13, the CPU 201 determines whether the version of the FW and the FPGA data stored in the storage of the optional modules detected at Step S12 is newer than that of the FW and the FPGA data stored in the main storage (storage 203). At Step S13, the CPU 201 compares the version status information of the FW and the FPGA data stored in the storage 203 with the version status information of the FW and the FPGA stored in the storage of all the optional modules determined to be connected at Step S11.

If the CPU 201 determines that the version of the FW and the FPGA data stored in the storage of the optional modules detected at Step S12 is newer than that of the FW and the FPGA data stored in the main storage (Yes at Step S13), the process proceeds to Step S14. If the CPU 201 determines that the version of the FW and the FPGA data stored in the storage of the optional modules detected at Step S12 is older than that of the FW and the FPGA data stored in the main storage (No at Step S13), the process proceeds to Step S15.

At Step S14, the CPU 201 loads the FW and the FPGA data stored in the storage of the optional modules detected at Step S12 onto the work memory 201b. At Step S15, the CPU 201 loads the FW and the FPGA data stored in the main storage (storage 203) onto the work memory 201b. After the processing at Step S14 or Step S15, the process proceeds to Step S16.

At Step S16, the CPU 201 configures the mechanical unit controller 201a based on the FW loaded on the work memory 201b and starts the operation of the mechanical unit 200.

At Step S13, the CPU 201 compares the version of the FW and the FPGA data stored in the main storage with the version of the FW and the FPGA data stored in the storage of all the optional modules detected at Step S12. The CPU 201 may load, out of all the FW and the FPGA data that have been compared to determine which FW and FPGA data are of the newest version, the newest FW onto the work memory 201b and download the newest FPGA data to the FPGA data storage 202a. Alternatively, the CPU 201 may load, out of all the FW and the FPGA data that have been compared to determine which FW and FPGA data are of the newest version, the newest FW onto the work memory 201b and download FPGA data corresponding to this FW to the FPGA data storage 202a. The FPGA data corresponding to the FW is FPGA data stored in the same storage as the FW.

According to the first embodiment above, when the mechanical unit 200 is activated, the firmware stored in the main storage (storage 203) is loaded onto the work memory 201b. The CPU 201 that operates based on the firmware checks whether optional modules are connected. The CPU 201 then determines whether the optional modules determined to be connected include a storage that stores firmware and FPGA data. If the optional modules include a storage, the CPU 201 reads the firmware from the storage of the optional modules and loads the firmware onto the work memory 201b. The CPU 201 also reads the FPGA data from the storage of the optional modules and downloads the FPGA data to the FPGA data storage 202a, and then configures the FPGA 202 based on the FPGA data.

According to the first embodiment, new functions can be easily added at the build-out of the optional modules by only installing, to the optional modules, the newest FW and FPGA data that support the additional functions and operations of the mechanical modules provided by the optional modules. This configuration allows for the initial development of the paper currency handling apparatus without consideration of optional functions that may be added in the future, thereby achieving rapid development. Since the FW and the FPGA data are updated automatically, functions that are unpredicted at the time of the development of the paper currency handling apparatus can be added more flexibly.

(Modification of First Embodiment)

(1) Storage of Firmware and FPGA Data in Mechanical Unit

In the first embodiment above, the mechanical unit 200 such as the paper currency unit 90 includes the main storage 93 and stores firmware in the firmware storage 93a and FPGA data in the FPGA data storage 93b. However, the configuration of the mechanical unit 200 is not limited to this. The mechanical unit 200 may exclude the main storage 203, and the storage may be included only in the mechanical modules 204-1, 204-2, or in the optional modules 206-1, 206-2. In this case, the mechanical unit 200 configures the FPGA by using the firmware and the FPGA data stored in the mechanical modules 204-1, 204-2 or in the optional modules 206-1, 206-2 to control the mechanical modules and the optional modules connected to the FPGA.

(2) Execution Timing of Function Addition and Update Processing of Mechanical Modules

In the first embodiment above, the function addition and update processing of the mechanical modules is performed when the paper currency handling apparatus 100 is powered on and the mechanical unit 200 is activated. However, the execution timing of the function addition and update processing is not limited to this. The processing may be performed when the paper currency handling apparatus 100 is in operation and the optional modules 206-1, 206-2 are newly connected to the mechanical unit 200 via the optional module I/Fs 205-1, 205-2.

(3) Target to be Updated

In the first embodiment above, both firmware and FPGA data are updated, but the target to be updated is not limited to this. The target to be updated may be one of the firmware and the FPGA data.

(4) Omission of Comparison Between Versions of Firmware and FPGA Data

In the first embodiment, versions of the firmware and the FPGA data stored in the storages of the optional modules 206-1, 206-2 are compared with the version of the firmware and the FPGA data stored in the main storage. However, the comparison of versions may be omitted when the newly connected optional modules 206-1, 206-2 include a storage. In this case, the firmware may be read from the storage and loaded onto the CPU 201, and then the FPGA data may be read from the storage to configure the FPGA 202.

(5) Adding and Updating Function of Existing Mechanical Modules Using Optional Modules

In the first embodiment above, the optional module 206-1 includes the optional function part 206-13, but the configuration is not limited to this. In other words, the optional module 206-1 may exclude the optional function part 206-13, and may store firmware and FPGA data for use in updating, that is, adding functions to or modifying functions of the existing mechanical modules in the storage 206-12. This configuration can add functions to or modify functions of the existing mechanical modules 204-1, 204-2 with the mechanical modules 204-1, 204-2 being connected.

(6) Replacement of Existing Mechanical Modules

In the first embodiment above, for example, the existing mechanical modules such as the deposit and withdrawal part 94-1 to the conveyor part 94-6 may be connected to the FPGA 92 via the interfaces similar to the optional module I/Fs 95-1, 95-2. In this structure, the existing mechanical modules may be replaced with mechanical modules similar to the optional modules 96-1, 96-2. In this regard, the firmware and the FPGA data can be automatically updated by only replacing the mechanical modules, and with regard to the existing functions, new functions can be added or the existing functions can be modified easily.

(7) Function Addition and Update Processing of Mechanical Modules Using Firmware Updater

In the first embodiment above, the IPL of the firmware stored in the firmware storages 93a, 203a is an IPL that can perform the function addition and update processing of the mechanical modules illustrated in FIG. 8. However, at the shipping of the paper currency handling apparatus 100, the IPL of the firmware stored in the firmware storages 93a, 203a may fail to support the function addition and update processing of the mechanical modules illustrated in FIG. 8. In this regard, the CPU 10 of the paper currency handling apparatus 100 may be configured to update the firmware stored in the firmware storages 93a, 203a automatically or in accordance with an update instruction by using the updater stored in the firmware storage 20a. The CPU 10 may update only the IPL of the firmware stored in the firmware storages 93a, 203a. This configuration allows the paper currency handling apparatus 100 not supporting the function addition and update processing of the mechanical modules described in the first embodiment to support the function addition and update processing of the mechanical modules according to the first embodiment.

### Second Embodiment

(General Configuration of Mechanical Unit in Paper Currency Handling Apparatus According to Second Embodiment)

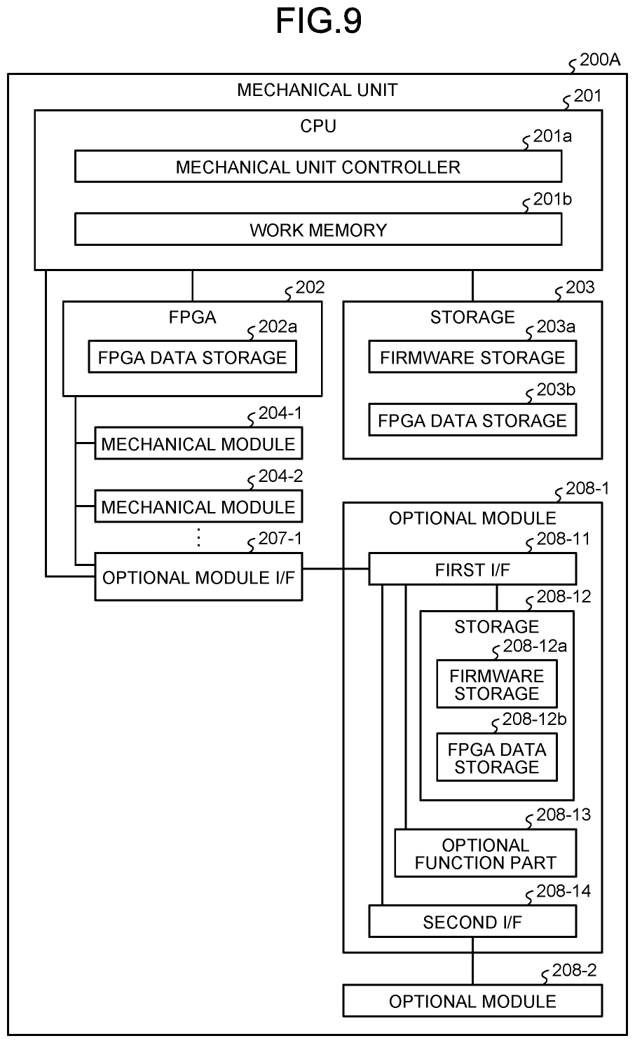

In the first embodiment above, a plurality of optional modules installed in the mechanical unit 200 are connected in parallel with each other to the FPGA 202. However, the connection architecture of the optional modules is not limited to this. The optional modules installed in the mechanical unit 200 may be connected to the FPGA 202 in series. FIG. 9 is a diagram illustrating an example general configuration of a mechanical unit in a paper currency handling apparatus according to a second embodiment.

Compared to the mechanical unit 200 according to the first embodiment, this mechanical unit 200A according to the second embodiment includes one optional module I/F 207-1 instead of the optional module I/Fs 205-1, 205-2. The optional module I/F 207-1 is connected to the CPU 201 to detect the connection of optional modules 208-1, 208-2.

The optional module 208-1 connected via the optional module I/F 207-1 includes a first I/F 208-11, a storage 208-12, an optional function part 208-13, and a second I/F 208-14. The storage 208-12 includes a firmware storage 208-12a and an FPGA data storage 208-12b. The storage 208-12, the firmware storage 208-12a, and the FPGA data storage 208-12b have the same configurations as the storage 206-12, the firmware storage 206-12a, and the FPGA data storage 206-12b, respectively. The optional function part 208-13 has the same configuration as the optional function part 206-13.

The first I/F 208-11 is connected with the storage 208-12 and the optional function part 208-13 in the same manner as the I/F 206-11. In addition, the first I/F 208-11 is connected with the second I/F 208-14. The second I/F 208-14 is connected with the other optional module 208-2.

In other words, in the second embodiment, the optional modules 208-1, 208-2 are connected to the FPGA 202 in series via the single optional module I/F 207-1. In the second embodiment, detecting the connection of the optional modules 208-1, 208-2, determining whether the optional modules 208-1, 208-2 include a storage, and reading firmware and FPGA data from the storage are performed in the same manner as in the first embodiment.

In the mechanical unit 200A according to the second embodiment, the optional modules 208-1, 208-2 are connected in series. Providing a single optional module I/F 207-1 can increase the maximum number of optional modules to be connected, and thus can increase the number of optional modules flexibly.

The configurations of the elements described in the embodiments above can be modified, added, or omitted within the scope of the paper sheet handling apparatus and the method of configuring the PLD in the paper sheet handling apparatus according to the present disclosure. The embodiments above are presented for illustrative purposes only, and aspects in the description and various other aspects modified or improved based on the knowledge of those skilled in the art are included in the present disclosure.

According to an example of the present disclosure, the paper sheet handling apparatus can easily add functions to the mechanical modules.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A paper sheet handling apparatus comprising:
a plurality of mechanical units including a paper sheet handling unit, the plurality of mechanical units each including
a processor,
a programmable logic device (PLD) controlled by the processor,
a first mechanical module including a first mechanical element controlled by the PLD, and
an interface that connects a second mechanical module including a second mechanical element, wherein
when the processor detects connection of the second mechanical module via the interface, the processor reads, from a second storage included in the second mechanical module, the second storage storing second firmware of the processor configured to control the first mechanical element and the second mechanical element and second data for use in configuring a logic circuit of the PLD configured to control the first mechanical element and the second mechanical element, the second firmware to load the second firmware onto the processor, and the processor reads the second data from the second storage to configure the PLD.

2. The paper sheet handling apparatus according to claim 1, further including:
a first storage that stores
first firmware of the processor configured to control the PLD and the first mechanical element and
first data for use in configuring the logic circuit of the PLD configured to control the first mechanical element, wherein
when the processor detects no connection of the second mechanical module via the interface, or when the processor detects connection of the second mechanical module via the interface but the second mechanical module includes no second storage, the processor reads the first firmware from the first storage to load the first firmware onto the processor and reads the first data from the first storage to configure the PLD.

3. The paper sheet handling apparatus according to claim 2, wherein, when the second mechanical module includes the second storage, the processor determines whether the second firmware and the second data are newer than the first firmware and the first data, and when the second firmware and the second data are newer than the first firmware and the first data, the processor reads the second firmware to load the second firmware onto the processor and reads the second data to configure the PLD, and when the first firmware and the first data are newer than the second firmware and the second data, the processor reads the first firmware to load the first firmware onto the processor and reads the first data to configure the PLD.

4. The paper sheet handling apparatus according to claim 1, wherein, when the processor detects connection of a plurality of second mechanical modules via the interface and the second mechanical modules each include the second storage, the processor reads the newest second firmware of the second firmware stored in the second storages to load the newest second firmware onto the processor and reads the newest second data of the second data stored in the second storages to configure the PLD.

5. The paper sheet handling apparatus according to claim 1, wherein
the mechanical units each include a plurality of interfaces, and
the second mechanical module includes a plurality of second mechanical modules connected in parallel with each other to the PLD via the interfaces.

6. The paper sheet handling apparatus according to claim 1, wherein
the mechanical units each include a single interface, and
the second mechanical module includes a plurality of second mechanical modules connected in series to the PLD via the interface.

7. The paper sheet handling apparatus according to claim 1, further including:
a host processor configured to control the plurality of mechanical units, and
a storage that stores an updater of firmware for the processor included in each mechanical unit.

8. A method of configuring a programmable logic device (PLD) in a paper sheet handling apparatus including a plurality of mechanical units including a paper sheet handling unit, the plurality of mechanical units each comprising
a processor,
a PLD controlled by the processor,
a first mechanical module including a first mechanical element controlled by the PLD, and
an interface that connects a second mechanical module including a second mechanical element, wherein
when the processor detects connection of the second mechanical module via the interface, the processor reads, from a second storage included in the second mechanical module, the second storage storing second firmware of the processor configured to control the first mechanical element and the second mechanical element and second data for use in configuring a logic circuit of the PLD configured to control the first mechanical element and the second mechanical element, the second firmware to load the second firmware onto the processor, and the processor reads the second data from the second storage to configure the PLD.
